(19) United States
(12) Patent Application Publication
(10) Pub. No.: US 2025/0045104 A1
(43) Pub. Date: Feb. 6, 2025

(54) STORAGE DEVICE USING MACHINE LEARNING AND OPERATING METHOD THEREOF

(71) Applicant: Samsung Electronics Co., Ltd., Suwon-si (KR)

(72) Inventors: Kibeen JUNG, Suwon-si (KR); Minkyu KIM, Suwon-si (KR); Hankyoo LEE, Suwon-si (KR); Namhoon KIM, Suwon-si (KR); Byeonghui KIM, Suwon-si (KR); Jisoo KIM, Suwon-si (KR); Hyunkyo OH, Suwon-si (KR)

(73) Assignee: Samsung Electronics Co., Ltd., Suwon-si (KR)

(21) Appl. No.: 18/409,286

(22) Filed: Jan. 10, 2024

(30) Foreign Application Priority Data
Aug. 2, 2023 (KR) 10-2023-0100872

(51) Int. Cl. G06F 9/50; G06F 1/324

(52) U.S. Cl. CPC G06F 9/5016; G06F 1/324; G06F 9/5094

(57) ABSTRACT

A storage device includes at least one nonvolatile memory device, and a controller controlling the at least one nonvolatile memory device. The controller includes a parameter storage storing a power parameter indicating a clock value of each of internal configurations for each power state. The power parameter is a value derived by performing machine learning considering performance, peak power, and average power.

### CROSS-REFERENCE TO RELATED APPLICATION(S)

This application claims the benefit under 35 USC 119(a) of Korean Patent Application No. 10-2023-0100872 filed on Aug. 2, 2023 in the Korean Intellectual Property Office, the entire disclosure of which is incorporated herein by reference for all purposes.

### BACKGROUND

The present inventive concepts relate to a storage device using machine learning and a method of operating the same.

In general, for storage devices, maintaining or improving performance while significantly reducing power usage is an important challenge. Machine learning may help solve these challenges. Machine learning algorithms may be used to learn and predict patterns of input/output (I/O) requests. For example, future I/O requests may be predicted by learning user behavior or application behavior patterns. These predictions may be used to reduce unnecessary power consumption. For example, machine learning algorithms may identify times when I/O requests are low and put storage devices into low-power modes during these times. Machine learning may also be used to optimize data placement and provisioning strategies. Algorithms learn the access patterns of data and may reduce power consumption by placing frequently accessed data in efficient areas of the storage device and infrequently accessed data in less efficient areas.

### SUMMARY

Example embodiments provide a storage device in which power efficiency may be improved and a method of operating the same.

According to example embodiments, a storage device includes at least one nonvolatile memory device; and a controller controlling the at least one nonvolatile memory device. The controller includes a parameter storage storing a power parameter indicating a clock value of each of a plurality of internal configurations for each power state of each of the at least one internal component. The power parameter is derived by performing a machine learning operation using a machine learning model trained to output the power parameter based on performance, peak power, and average power of the storage device.

According to example embodiments, a method of operating a storage device includes setting a power parameter using machine learning; and adjusting a frequency of at least one active or inactive device based on the set power parameter. The adjusting of the frequency includes at least one of dividing a clock corresponding to the frequency; gating the clock; or gearing the clock.

According to example embodiments, a method of operating a storage device includes receiving a machine learning execution request from a host device; performing a machine learning operation in response to the machine learning execution request; and setting a parameter according to a result of execution of the machine learning operation. The parameter is a value derived considering performance, peak power, and average power.

According to example embodiments, a storage device includes at least one nonvolatile memory device; and a controller controlling the at least one nonvolatile memory device. The controller includes an artificial intelligence processor configured to derive a power parameter using machine learning, the power parameter indicating a clock value of each of a plurality of internal components; and a parameter storage storing the power parameter.

### BRIEF DESCRIPTION OF DRAWINGS

The above and other aspects, features, and advantages of the present inventive concepts will be more clearly understood from the following detailed description, taken in conjunction with the accompanying drawings, in which:

FIG. 1A is a diagram conceptually illustrating a process of improving power efficiency of a storage device (SSD) 10 according to at least one example embodiment;

FIG. 1B is a diagram illustrating a parameter optimizer 24 according to at least one example embodiment;

FIG. 2 is a diagram illustrating a storage device according to at least one example embodiment;

FIG. 3 is a diagram illustrating a nonvolatile memory device 100 illustrated in FIG. 2;

FIG. 4 is a diagram illustrating a general process of tuning clocks for respective companies;

FIGS. 5A and 5B are diagrams illustrating an optimization process according to requirements of different companies by way of example;

FIG. 6 is a diagram illustrating a power state transition of a storage device according to at least one example embodiment;

FIG. 7A is a diagram illustrating clock division of a storage device according to at least one example embodiment;

FIG. 7B is a diagram illustrating clock gating of a storage device according to at least one example embodiment;

FIG. 8 is a diagram illustrating at least one example of clock gearing according to at least one example embodiment;

FIG. 9 is a diagram illustrating at least one example of a frequency control method for each core in a storage device according to at least one example embodiment;

FIG. 10 is a flowchart illustrating a method of operating a storage device according to at least one example embodiment;

FIG. 11 is a diagram illustrating a storage device 10a according to another example embodiment;

FIG. 12 is a diagram illustrating an internal operation of a parameter optimization module 14 of a storage device 10a according to at least one example embodiment;

FIG. 13 is a ladder diagram illustrating the operation of a storage device according to at least one example embodiment, by way of example;

FIG. 14 is a diagram illustrating a storage device 40 according to another embodiment; and

FIG. 15 is a diagram illustrating a host system according to at least one example embodiment.

### DETAILED DESCRIPTION

Hereinafter, example embodiments will be described with reference to the accompanying drawings, wherein like reference numerals refer to like elements throughout. In this regard, the present embodiments may have different forms and should not be construed as being limited to the particular descriptions set forth herein.

According to at least one embodiment of the present invention, a storage device and an operating method thereof may improve power efficiency using machine learning. The storage device and the operating method may optimize a clock to minimize power consumption while meeting performance requirements, considering the trade-off between performance and power consumption. The present invention may be implemented with a machine learning module determining power-related parameter values and an aggregator that reads performance and power consumption as inputs, deriving a synthesized scalar value. The storage device and the operating method may reduce human resources wasted in parameter optimization, meeting performance requirements and minimizing power consumption. Thus, the storage device and the operating method may decide the clock considering the trade-off between performance and power using the machine learning model, and set different clocks for different devices.

Generally, the power efficiency of a storage device varies greatly depending on clock values of internal devices like cores, buses, and NAND flash memories. With the change in the clock values, performance and power consumption can differ significantly, and as performance increases, so does power consumption. In particular, the peak power and average power change significantly depending on the clock combination of each device. Because the determination of the clock value greatly affects performance and power consumption, due to the existing trade-off between performance and power, it is also not easy to dynamically reduce power consumption while satisfying performance requirements. Also, a trade-off exists among different workloads. If the clock of a non-bottleneck device is lowered in a specific workload, the power consumption of the storage device in that workload also decreases. However, if the clock of that device is lowered when it's a bottleneck in another workload, the performance of the storage device, as a whole, may deteriorate. Further, changes to the clock cannot be practically performed by the human mind as the dynamic changes to the performance and power consumption conditions to the clock values of the internal devices may require monitoring, considerations, customization, and/or decisions, at scales outside the practical capacity the human mind.

The present invention may automatically determine the optimal value of the device-specific clock, considering the trade-offs using machine learning (for instance, using a Bayesian Optimization). As a result, the storage device and the operating method may increase and/or maximize the power efficiency of the storage device and save development manpower wasted in the clock tuning process.

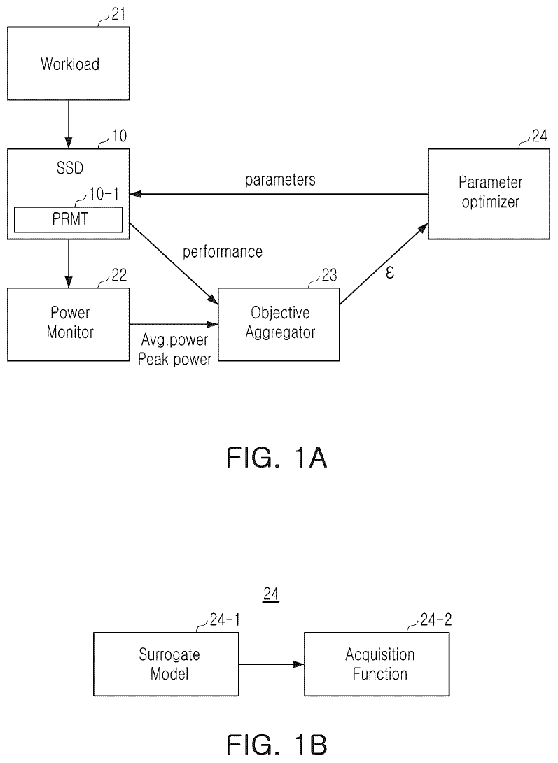

FIG. 1A is a diagram conceptually illustrating a process of improving power efficiency of a storage device (SSD) 10 according to at least one example embodiment. As illustrated in FIG. 1A, an optimal clock value satisfying performance requirements and minimizing power consumption may be determined by considering trade-offs using Bayesian optimization outside of the storage device 10.

The process of determining the parameters of the storage device 10 is as follows. Initially, the clock value is determined randomly, and parameters corresponding to the determined clock values are applied to the storage device 10. Afterwards, the storage device 10 may repeatedly perform the workload 21. The power monitor 22 may measure the actual power consumption of the storage device 10. The objective aggregator 23 may collect the measured throughput performance and power consumption (e.g., average power or peak power) of the storage device 10.

In at least one embodiment, the objective aggregator 23 may include an objective function. In these cases, the objective function may be composed of multiple objectives such as throughput, peak power, and average power. For example, the objective aggregator 23 may be configured to perform a single-objective Bayesian optimization. For example, when performing optimization using multi-objective Bayesian optimization, there is no need to aggregate multi-objectives; however, when performing optimization using single-objective Bayesian optimization, it is necessary to collect multiple objectives into one scalar value. As such, the single-objective optimization does not directly use performance and power consumption figures, but optimizes parameters by observing the scalar value that aggregates the same.

In at least one example embodiment, the power parameter may indicate the clock value of each of the internal components, when a power state of the respective internal components of the storage device 10 is one of an active state, a background operation state, an idle state, or a sleep state. In these cases, the clock value may be adjusted using a clock division value, clock gating value, and/or clock gearing value.

The parameter optimization process according to at least one example embodiment may use an objective aggregator 23 specialized for optimizing the power of the storage device 10. The formula below represents deriving one scalar value (f(clocks);ε) from the objective aggregator 23 of the present inventive concepts.

$$( clocks ) = \frac{1}{2} ( \frac{1}{2 N} ( {\sum }_{i}^{N} {w}_{1} \cdot avg . power {improvment}_{i} + {w}_{2} \cdot peak power {improvement}_{i} ) + \frac{1}{N} {\sum }_{i}^{N} {w}_{3} \cdot performance {improvement}_{i} ) \qquad [ Equation 1 ]$$

where w₁=α(if avg. power improvement>0), β(else),

w₂=γ(if peak power improvment>0), δ(else),

w₃=0(if performance improvment>0), ε(else),

α,β,γ,δ>0.

As such, the objective aggregator 23 may define priority between objectives by considering the specifications, aggregate multiple objectives in a way that minimizes trade-offs between objectives, and derive one scalar value (ε) using the aggregated objectives.

The parameter optimizer 24 may determine parameter values using Bayesian optimization for the actually measured collected data. When the randomly determined clock value and the performance/power value when the same is applied are accumulated as data, the surrogate model of Bayesian optimization may be trained to predict an objective function that derives performance and power according to clock input based on the accumulated data. For example, the parameter optimizer 24 may be configured to determine parameters corresponding to clock values expected to minimize power consumption while satisfying performance requirements in the predicted objective function. The parameters determined in this manner may be set in the storage device 10. For example, the parameter storage 10-1 (PRMT) of the storage device 10 may store set parameters. In this case, the parameter storage 10-1 may be implemented as a nonvolatile memory or a volatile memory. Afterwards, the performance/power values of the storage device 10 may be observed by performing a benchmark workload again.

FIG. 1B is a diagram illustrating the parameter optimizer 24 according to at least one example embodiment. Referring to FIG. 1B, the parameter optimizer 24 may include a surrogate model 24-1 and an acquisition function 24-2. Herein, for clarity of description it will be said that the parameter optimizer 23 uses Bayesian optimization, but the example embodiments are not limited thereto. The parameter optimizer 24 may determine the optimal clock from the objective function through the following process: n clocks may be randomly sampled based on the upper and lower limits of predefined (and/or otherwise determined) clock values; the surrogate model 24-1 may derive the predicted value and standard deviation value of the objective function value (performance/power) of randomly sampled clocks; and the acquisition function 24-2 may determine the optimal clock value based on the predicted value and standard deviation. For example, the optimal clock value may be determined based on reward and/or reinforcement algorithms towards lowering the power consumption of the predicted value while maintaining a larger standard deviation (uncertainty). Then, newly added data may be accumulated from the existing data; and when the data is updated, the surrogate model 24-1 may predict the objective function again and determine the optimal clock value again. As this process is repeated, the data increases and the prediction accuracy for the objective function may increase and the standard deviation may decrease. Gradually, through repetition, the probability that an optimal clock will be found increases.

On the other hand, in the domain of the storage device 10, optimal parameters may be defined as a set of parameters that satisfy a customer and/or user's specifications. In at least one example embodiment, for multi-objective Bayesian optimization, the parameter optimizer 24 may simply find the Pareto front without defining priorities between objectives. wherein Pareto front includes a set of multiple solutions, and these solutions have an optimal solution satisfying each objective function to the maximum or minimum without any further improvement of the solution. In these cases, the Pareto front may compare which solution is better when the value of one objective function should be sacrificed to improve the value of another objective function among the optimized solutions. In another embodiment, the parameter optimizer 24 may use the objective aggregator 23 to define priorities between objectives and define optimal parameters in terms of specifications.

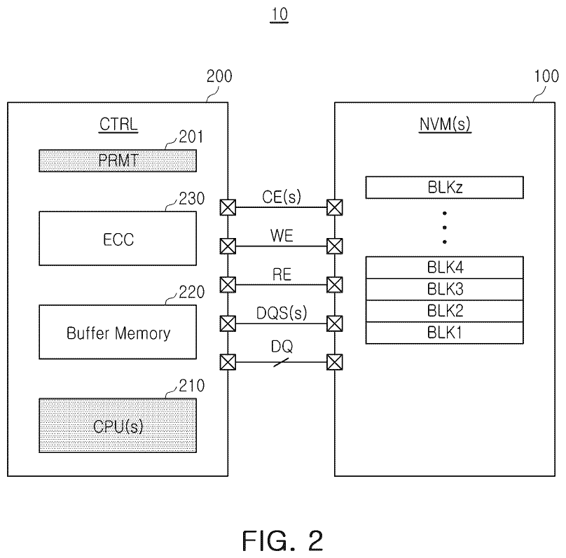

FIG. 2 is a diagram illustrating a storage device 10 according to at least one example embodiment. Referring to FIG. 2, the storage device 10 may include at least one nonvolatile memory device (NVM(s); 100) and a controller (CTRL) 200.

At least one nonvolatile memory device 100 may be implemented to store data. In at least one embodiment, the nonvolatile memory device 100 may be NAND flash memory, vertical NAND flash memory, NOR flash memory, resistive random access memory (RRAM), phase-change memory (PRAM), magnetoresistive memory (e.g., magnetoresistive random access memory; MRAM), ferroelectric random access memory (FRAM), spin transfer torque random access memory (STT-RAM), and/or the like. Additionally, the nonvolatile memory device 100 may be implemented in a three-dimensional array structure.

The nonvolatile memory device 100 may be implemented to include a plurality of memory blocks (BLK1 to BLKz, where z is an integer of 2 or more). Each of the plurality of memory blocks (BLK1 to BLKz) may include a plurality of pages (Page 1 to Page m, where m is an integer of 2 or more). Each of the plurality of pages (Page 1 to Page m) may include a plurality of memory cells. Each of the plurality of memory cells may store at least one bit. The nonvolatile memory device 100 may be implemented to receive a command and an address from the controller (CTRL) 200, and perform an operation (program operation, read operation, erase operation, etc.) corresponding to the received command on memory cells corresponding to the address.

The controller (CTRL) 200 may be connected to at least one of the nonvolatile memory devices 100 through a plurality of control pins that transmit control signals (e.g., ALE, CE(s), WE, RE, etc.). Additionally, the nonvolatile memory device 100 may be controlled using control signals (CE(s), WE, RE, etc.). For example, during a read operation, the chip enable signal (CE) is activated, a command latch enable signal (CLE) is activated in the transmission section of the command, an address latch enable signal (ALE) is activated in the transmission section of the address, and read enable signal (RE) may be toggled in the section where data is transmitted through the data signal (DQ). The data strobe signal (DQS) may be toggled with a frequency corresponding to the data input/output speed. Read data may be transmitted sequentially in synchronization with the data strobe signal (DQS).

Additionally, the controller 200 may include a parameter storage 201 (PRMT), at least one processor (Central Processing Unit; CPU) 210, a buffer memory 220, and an error correction circuit 230 (ECC).

The parameter storage 201 may store parameters for optimal performance/power of the storage device 10. In these cases, the parameters may be input from the outside when the storage device 10 is shipped or when the storage device is turned on. In at least one example embodiment, parameters may be input from parameter optimizer 24 illustrated in FIG. 1. The clock value of each of the internal components of the storage device 10 may be determined according to these parameters.

The processor 210 may be implemented to control the overall operation of the storage device 10. The processor 210 may perform various management operations such as cache/buffer management, firmware management, garbage collection management, wear leveling management, data deduplication management, read refresh/reclaim management, bad block management, multi-stream management, mapping management of host data and nonvolatile memory, Quality of Service (QoS) management, system resource allocation management, nonvolatile memory queue management, read level management, erase/program management, hot/cold data management, power loss protection management, dynamic thermal management, initialization management, Redundant Array of Inexpensive Disk (RAID) management, and/or the like.

The buffer memory 220 may be implemented as volatile memory (e.g., Static Random Access Memory (SRAM), Dynamic RAM (DRAM), Synchronous RAM (SDRAM), and/or the like) and/or nonvolatile memory (flash memory, PRAM (Phase-change RAM), MRAM (Magneto-resistive RAM), ReRAM (Resistive RAM), FRAM (Ferro-electric RAM), and/or the like).

The error correction circuit 230 may be implemented to generate an error correction code (ECC) during a program operation and to recover data using the error correction code during a read operation. For example, the error correction circuit 230 may generate an error correction code to correct fail bits or error bits of data received from the nonvolatile memory device 110. Additionally, the error correction circuit 230 may perform error correction encoding of data provided to the nonvolatile memory device 110, and may form data with a parity bit added. Parity bits may be stored in the nonvolatile memory device 110. Additionally, the error correction circuit 230 may perform error correction decoding on data output from the nonvolatile memory device 110. The error correction circuit 230 may correct errors using parity. The error correction circuit 230 may correct errors using Low Density Parity Check (LDPC) code, BCH code, turbo code, Reed-Solomon code, convolution code, Recursive Systematic Code (RSC), Trellis-Coded Modulation (TCM), Block Coded Modulation (BCM) Coded modulation, or the like. On the other hand, when error correction is not possible in the error correction circuit 230, a read retry operation may be performed.

The storage device 10 according to at least one example embodiment may improve power efficiency by operating at an optimal clock value for each workload according to the power state using parameters stored in the parameter storage 201. For example, the storage device 10 may execute Adaptive Clock Gearing (ACG) using parameters. In this case, ACG optimizes performance or reduces power consumption by dynamically adjusting the clock.

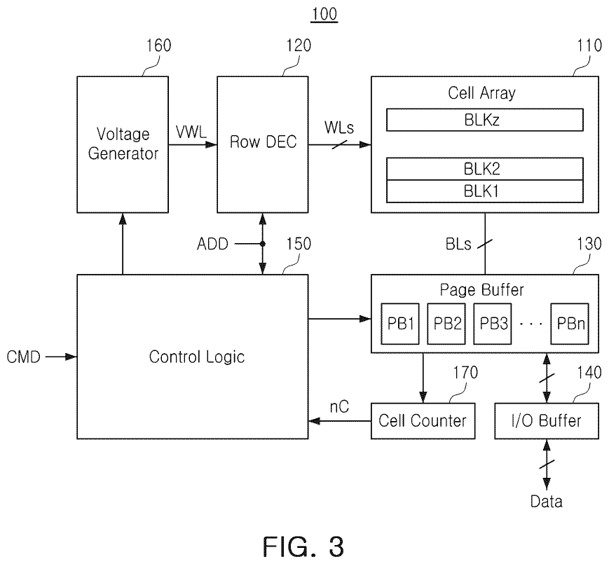

FIG. 3 is a diagram illustrating the nonvolatile memory device 100 illustrated in FIG. 2. Referring to FIG. 3, the nonvolatile memory device 100 may include a memory cell array 110, a row decoder 120, a page buffer circuit 130, an input/output buffer circuit 140, control logic 150, a voltage generator 160, and a cell counter 170.

The memory cell array 110 may be connected to the row decoder 120 through wordlines WLs or select lines SSL and GSL. The memory cell array 110 may be connected to the page buffer circuit 130 through bitlines BLs. The memory cell array 110 may include a plurality of cell strings. Each channel of the cell strings may be formed in a vertical or horizontal direction. Each of the cell strings may include a plurality of memory cells. In this case, a plurality of memory cells may be programmed, erased, or read by voltage provided to bitlines BLs or wordlines WLs. Generally, program operations are performed on a page basis, and erase operations are performed on a block basis. Details about memory cells will be described in US registered patents U.S. Pat. Nos. 7,679,133, 8,553,466, 8,654,587, 8,559,235, and 9,536,970.

In at least one example embodiment, the memory cell array 110 may include a three-dimensional memory cell array, and a three-dimensional memory cell array may include a plurality of NAND strings arranged along the row and column directions.

The row decoder 120 may be implemented to select one of the memory blocks BLK1 . . . BLKz of the memory cell array 110 in response to the address ADD. The row decoder 120 may select one of the wordlines of the selected memory block in response to the address ADD. The row decoder 120 may transmit a wordline voltage VWL corresponding to the operation mode to the wordline of the selected memory block. During a program operation, the row decoder 120 may apply a program voltage and a verification voltage to the selected wordline and a pass voltage to the unselected wordline. During a read operation, the row decoder 120 may apply a read voltage to the selected wordline and a read pass voltage to the unselected wordline.

The page buffer circuit 130 may be implemented to operate as a write driver or a sense amplifier. During a program operation, the page buffer circuit 130 may apply a bitline voltage corresponding to data to be programmed to the bitlines of the memory cell array 110. During a read operation or verification read operation, the page buffer circuit 130 may detect data stored in the selected memory cell through the bitline BL. Each of the plurality of page buffers (PB1 to PBn, n is an integer of 2 or more) included in the page buffer circuit 130 may be connected to at least one bitline.

The input/output buffer circuit 140 provides external data to the page buffer circuit 130. The input/output buffer circuit 140 may provide an external command CMD to the control logic 150. The input/output buffer circuit 140 may provide an externally provided address ADD to the control logic 150 or the row decoder 120. Additionally, the input/output buffer circuit 140 may output data sensed and latched by the page buffer circuit 130 to the outside.

The control logic 150 may be implemented to control the row decoder 120 and the page buffer circuit 130 in response to a command CMD transmitted from an external source (e.g., controller 200, see FIG. 2). The voltage generator 160 may be implemented to generate various types of wordline voltages to be applied to respective wordlines and a well voltage to be supplied to a bulk (e.g., well region) in which memory cells are formed, under the control of control logic 150. Wordline voltages applied to each wordline may include a program voltage, a pass voltage, a read voltage, and a read pass voltage. The cell counter 170 may be implemented to count memory cells corresponding to a specific threshold voltage range from data sensed by the page buffer circuit 130. For example, the cell counter 170 processes data sensed in each of the plurality of page buffers (PB1 to PBn), and the number of memory cells with a threshold voltage in a specific threshold voltage range may be counted.

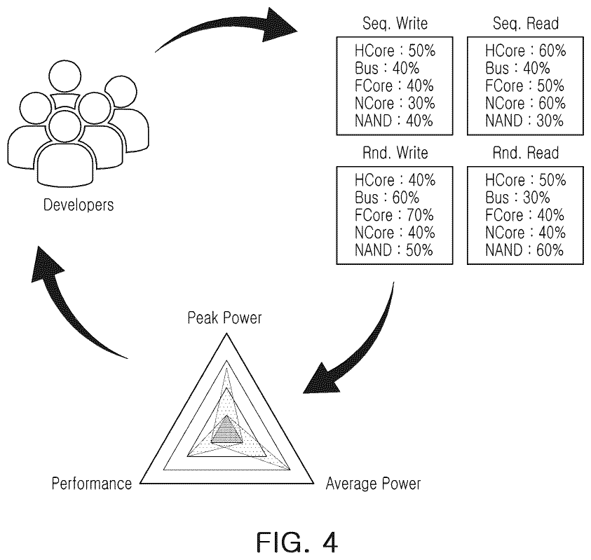

FIG. 4 is a diagram illustrating a process for generally tuning clocks for each company. Developers may typically manually adjust the power consumption of each configuration depending on the type of workload, such as sequential write, sequential read, random write, and random read. Through trade-offs between performance, average power, and peak power according to the company's requirements, developers find the optimal clock value by manually tuning the clock for each power state.

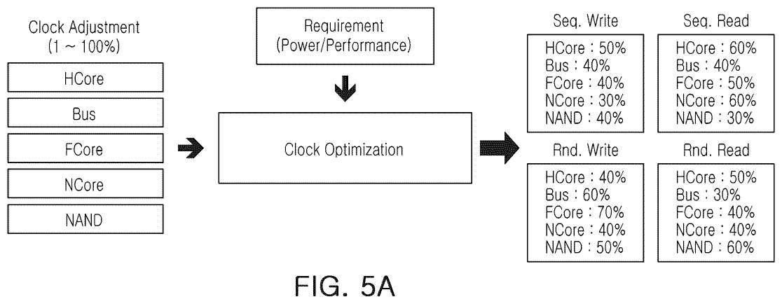

FIGS. 5A and 5B are diagrams illustrating examples of an optimization process according to the requirements of different companies. Referring to FIG. 5A, the company requirements are related to power/performance and achieve clock optimization. The clock factor may be configured as a percentage of the clock value of each of the configurations. Referring to FIG. 5B, the vendor requirements are to achieve quality of service (QoS) optimization in terms of performance/QoS/function. QoS influencing factors may consist of program, buffer size, core clock, firmware policy, and performance margin.

In general, storage devices may support power states as illustrated in Table 1. Referring to Table 1, power states include active state, background operating state, idle state, and sleep state.

TABLE 1

| Power State | Description |
|---|---|
| Active | State in which device processes commands |
| Background | There is no command, but processing |
| | internal background tasks |
| Idle | Step Low Power Mode. The internal |
| | implementation mainly uses the |
| | Dynamic Frequency Selection (DFS) |
| | method, and may also be called DFS. |
| Sleep | Stage 2 Low Power Mode. Dynamic |
| | power management (DPM) is used |
| | to turn off major modules from a |
| | hardware (H/W) perspective, and may |
| | also be called Power Gating (PG). |

Referring to Table 2, the power state descriptor includes various information such as max power, entry latency, and exit latency in addition to the non-operation state as provided in microseconds (us). The host software uses this information to perform power management. PS0, PS1, and PS2 are in operational power states and are in a state of processing I/O commands, but the slower the command is processed toward the back. PS3 and PS4 are low power modes that do not process I/O commands in a non-operational power state. PS3 may correspond to idle in the device power state, and PS4 may correspond to sleep in the device power state.

TABLE 2

| | | | Entry | Exit | Non-Operational |
|---|---|---|---|---|---|
| Power State | Max Power | | Latency | Latency | State |
| PS0 | 6 | W | 0 us | 0 us | No |
| PS1 | 5.0 | W | 0 us | 0 us | No |
| PS2 | 3.6 | W | 0 us | 0 us | No |
| PS3 | 40 | mW | 210 us | 1500 us | Yes |
| PS4 | 5 | mW | 2200 us | 6000 us | Yes |

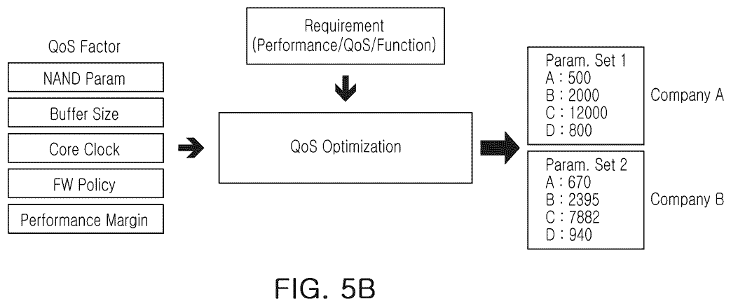

FIG. 6 is a diagram illustrating a power state transition of a storage device according to at least one example embodiment. When non-operation state (NOPS) of the power state descriptor is set to 1, this indicates that the power state is a non-operational power state. Therefore, I/O commands are not processed in that power state. The host device should wait until there are no pending I/O commands before issuing a set feature command to transition to a non-operational power state. At this time, the host device should not issue new I/O commands. In the case of a non-operational power state, the controller should switch to the most recent operational power state when the I/O submission queue tail doorbell is written.

The power state may be transitioned by a set feature command or Autonomous Power State Transitions (APST) requested by the host device. APST is when the device is idle for a certain period of time according to the settings of the host device in the NVMe specifications. This feature automatically transitions to a non-operational power state without host software intervention. The APST data structure specifies the transition conditions (ITPS, ITPT) from each power state to the non-operational power state. Idle Time Prior to Transition (ITPT) refers to the idle time required to transition power states. Idle Transition Power State (ITPS) indicates the power state to be transitioned to when the idle time in the corresponding power state exceeds ITPT. When APST is enabled, in the case in which it is idle for the ITPT time in the current power state, it should automatically transition to the power state specified in ITPS. The host device may change to ITPS and/or ITPT using the set feature command.

Table 3 is a diagram illustrating at least one example APST data structure table as measured in milliseconds (ms).

TABLE 3

| | Idle Time Prior to | Idle Transition Power |
|---|---|---|
| Power State | Transition(ITPT) | State(ITPS) |
| PS0 | 60 ms | PS3 |
| PS1 | 60 ms | PS3 |
| PS2 | 60 ms | PS3 |
| PS3 | 9940 ms | PS4 |
| PS4 | 0 | 0 |

On the other hand, the storage device 10 according to at least one example embodiment may control the clocks of each of the internal components by clock division, clock gating, and/or clock gearing indicated by parameters.

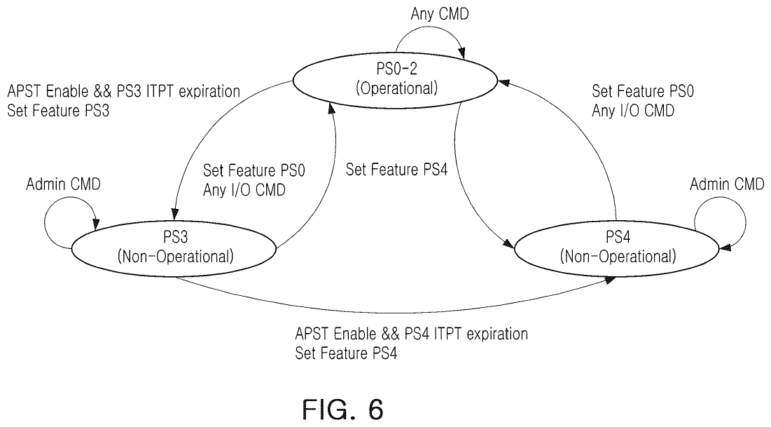

FIG. 7A is a diagram illustrating clock division of the storage device 10 according to at least one example embodiment. Clock division refers to dividing the clock. Power consumption may be reduced by lowering the clock by dividing the clock of the internal configuration by units of the power of 2 and applying the result. In the case of clock division, as illustrated in FIG. 7A, it may be applied by dividing by units of the power of 2.

FIG. 7B is a diagram illustrating clock gating of the storage device 10 according to at least one example embodiment. Referring to FIG. 7b, clock gating may reduce power consumption by controlling the gate that supplies the clock. Clock gating techniques require additional logic circuitry to provide or block the clock. In the case in which the operation of a specific circuit is not required, power consumption may be reduced by not supplying the clock to the specific circuit. However, to use clock gating, the controller (e.g., 200, see FIG. 2), the CPU, or SoC (System-on-Chip) should structurally support clock gating.

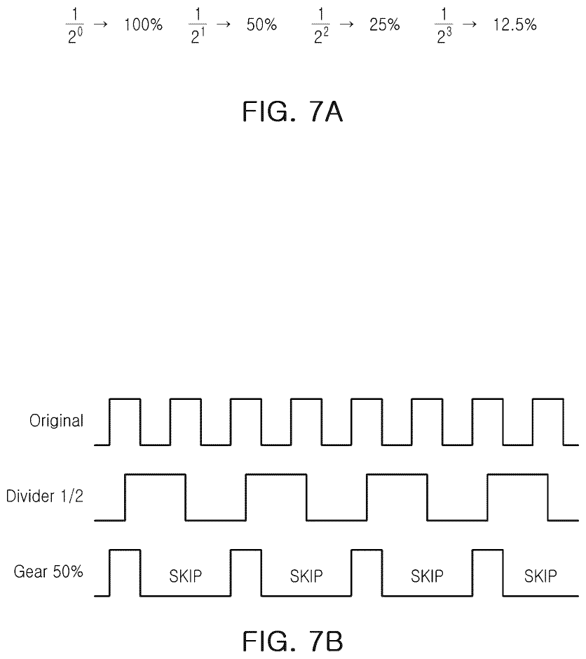

FIG. 8 is a diagram illustrating clock gearing of the storage device 10 according to at least one example embodiment. As illustrated, clock gearing may lower the clock by intentionally missing some pulses to reduce power consumption. Clock gearing allows for more precise clock control than clock dividing and clock gating. The implementation method depends on the controller (e.g., 200, see FIG. 2) that controls the clock gearing. In the controller, 2n−1 clock cycles at the input end constitute one edge at the output end in order to lower the clock frequency. On the other hand, clock gearing omits some of the clock pulses coming from the input stage to lower the clock frequency. As illustrated in FIG. 8, even if it is the same 50%, the resulting output waveform and timing are different when using clock gearing rather than clock division.

Table 4 is a diagram illustrating clock gearing of a storage device according to at least one example embodiment. There may be differences in the internal method of clock gearing applied to each controller. For example, clock gearing may be applied with a gearing count value and a divider value. In these cases, gearing count is a value that determines what clock pulse will be missed. (Gearing Count+1)th clock pulse is missing. In this case, the divider value is applied by dividing the clock by 2^{divider value}. As a result of applying clock gearing by combining Clock Divider and Gearing Count, clock adjustment is possible in approximately 5% increments.

TABLE 4

| Percent (%) | Divider Value | Gearing Count |
|---|---|---|
| 95 | 0 | 19 |
| 90 | 0 | 9 |
| 85 | 0 | 6 |
| 80 | 0 | 4 |
| 75 | 0 | 3 |
| 66 | 0 | 2 |
| 50 | 0 | 1 |
| 45 | 1 | 9 |
| 40 | 1 | 4 |
| 37 | 1 | 3 |
| 33 | 1 | 2 |
| 25 | 1 | 1 |
| 20 | 2 | 4 |
| 16 | 2 | 2 |
| 10 | 3 | 4 |
| 5 | 4 | 4 |

On the other hand, the storage device 10 may support Adaptive Clock Gearing ACG. In these cases, ACG enables precise clock adjustment at the 1% level. On the other hand, in Bayesian optimization, as long as only the observed values of the objective function may be obtained, optimization is possible even if the closed-form of the function cannot be defined. Because of these characteristics, Bayesian optimization may be mainly used to optimize hyperparameters of machine learning models.

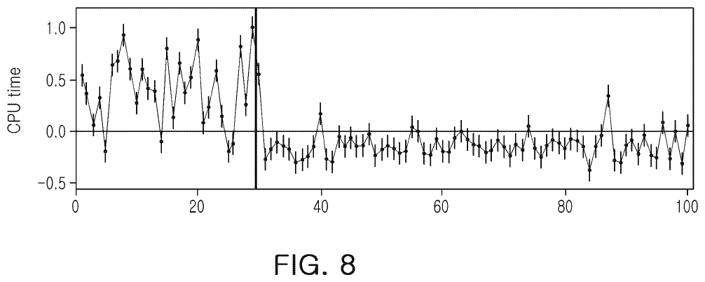

FIG. 9 is a diagram illustrating at least one example of a frequency control method for each core of the storage device 10 according to at least one example embodiment. Referring to FIG. 9, the first core is controlled with a fixed clock value in the active state, and the second core may be controlled with a clock value that varies in an inactive state according to power parameters. In this case, the clock value may be appropriately adjusted through clock division, clock gating, or clock gearing according to the set power parameters.

On the other hand, it should be understood that whether the first and second cores are activated and the clock control method may be applied in various ways depending on the power state.

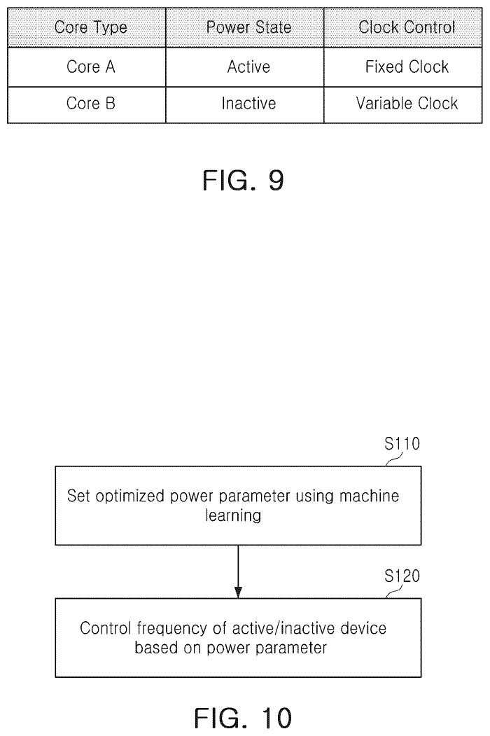

FIG. 10 is a flowchart illustrating a method of operating a storage device according to at least one example embodiment. Referring to FIGS. 1 to 10, the operation method of the storage device may proceed as follows. Power parameters may be set using machine learning (S110). For example, the machine learning may use a machine learning model trained based on accumulated data as discussed above in reference to FIG. 1A. The storage device may adjust the frequency of the active/deactivated device based on the power parameter (S120). In at least one example embodiment, the frequency may be adjusted by dividing the clock corresponding to the frequency, gating the clock, or gearing the clock.

In at least one example embodiment, power parameters may be derived using machine learning in an external device. For example, peak power and average power depending on workload may be monitored, one scalar value combining performance, peak power, and average power according to the workload may be derived, and the power parameters may be calculated by performing a machine learning operation, thereby deriving power parameters. In example embodiments, machine learning may use Bayesian optimization. In another embodiment, machine learning may be performed in an internal parameter optimization module in response to a request from the host device.

On the other hand, parameter settings of the present inventive concepts may be made inside the storage device in real time according to the request of the host device.

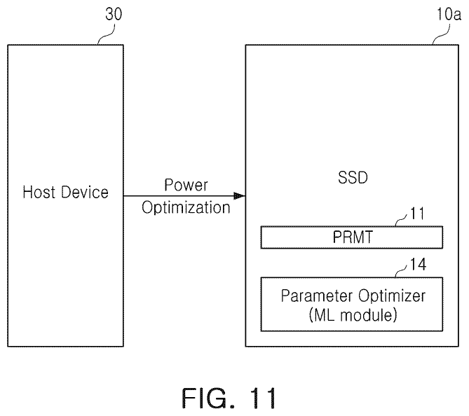

FIG. 11 is a diagram illustrating a storage device 10a according to another embodiment. Referring to FIG. 11, the host device 30 may request power optimization from the storage device 10a based on environmental information. In these cases, the environmental information may be environmental information (e.g., temperature, throughput, workload, service-related information, etc.) related to the host system and the storage device 10a. The storage device 10a may include a parameter storage device 11 and a parameter optimization module 14. The parameter optimization module 14 may find optimization parameters according to the workload using machine learning. Optimization parameters may be stored in a parameter store.

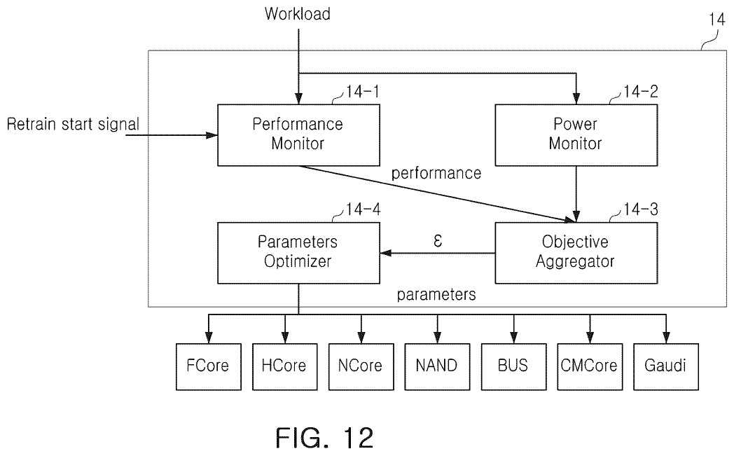

FIG. 12 is a diagram illustrating an example of the internal operation of the parameter optimization module 14 of the storage device 10a according to at least one example embodiment. Referring to FIG. 12, the parameter optimization module 14 may include a performance monitor 14-1, a power monitor 14-2, an objective aggregator 14-3, and a parameter optimizer 14-4. The performance monitor 14-1 may evaluate the performance of the storage device 10a based on parameters determined for each workload. The power monitor 14-2 may monitor peak power and average power for each workload. The objective aggregator 14-3 may receive performance information and power information and derive one scalar value. The parameter optimizer 14-4 may calculate optimal power parameters using machine learning.

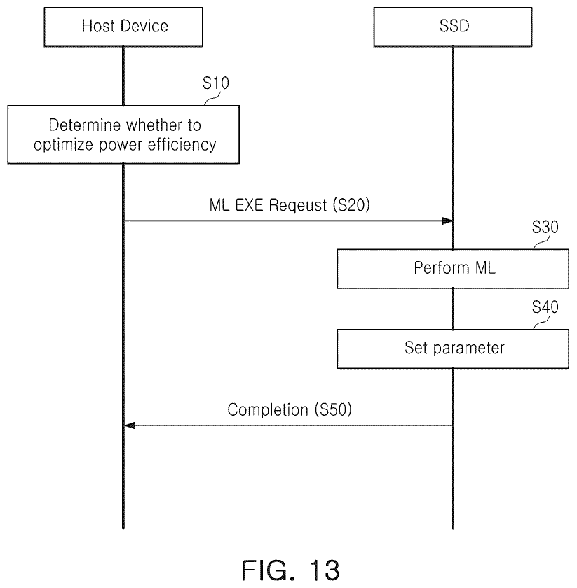

FIG. 13 is a ladder diagram illustrating an example of the operation of a storage device according to at least one example embodiment. Referring to FIG. 13, the host device may determine the need to optimize power efficiency (S10). When optimization of power efficiency is required and/or otherwise implemented, the host device may request machine learning activation from the storage device (S20). The storage device may perform a machine learning operation to achieve power optimization according to this machine learning performance request (S30). The storage device may set optimal power parameters according to machine learning performance (S40). Afterwards, the storage device may transmit machine learning performance completion information to the host device (S50).

In at least one example embodiment, the parameter may indicate clock values for each of the internal components of the storage device. In this case, the clock value may be appropriately adjusted using a clock division value, clock gating value, or clock gearing value. In another embodiment, the parameter may indicate quality parameters that determine service quality. In this case, the quality parameters may include at least two of the program operation parameters, buffer size, core clock, firmware policy, and/or performance margin.

In at least one example embodiment, the power states of the first core and the second core are determined, and when the first core is active and the second core is inactive, the clock value of the first core is fixed, and the clock value of the second core may be varied depending on the parameter. In example embodiments, performance and power consumption of a storage device may be received, one scalar value in which the performance and power consumption for each workload re synthesized may be derived, and machine learning may be further performed using the derived scalar value.

Additionally, the present inventive concepts may be implemented to improve power efficiency by an artificial intelligence processor inside a storage device.

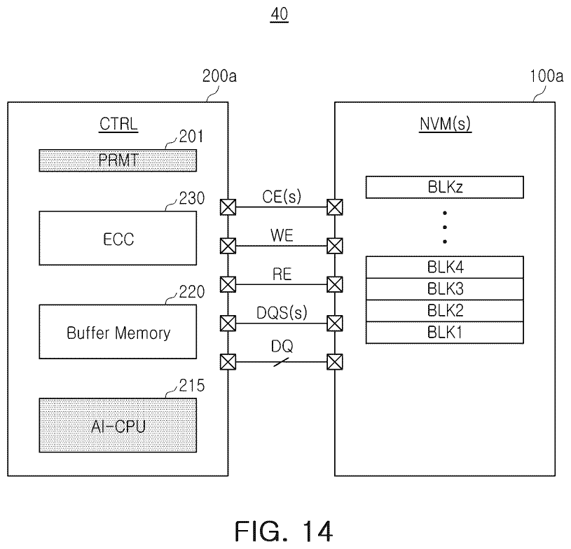

FIG. 14 is a diagram illustrating a storage device 40 according to another embodiment. Referring to FIG. 14, the storage device 40 may include at least one nonvolatile memory device 100a and a controller 200a that controls the nonvolatile memory device 100a. The storage device 40 may include an artificial intelligence processor 215 (AI-CPU) that performs parameter optimization using machine learning compared to that illustrated in FIG. 2.

In at least one example embodiment, machine learning may use Bayesian optimization to derive the power parameters by considering peak power and average power for each power state. The artificial intelligence processor 215 derives a scalar value that combines performance, peak power, and average power according to the workload, and the power parameters may be determined so that the derived scalar value is increased and/or maximized.

Additionally, the present inventive concepts are applicable to NVMe systems.

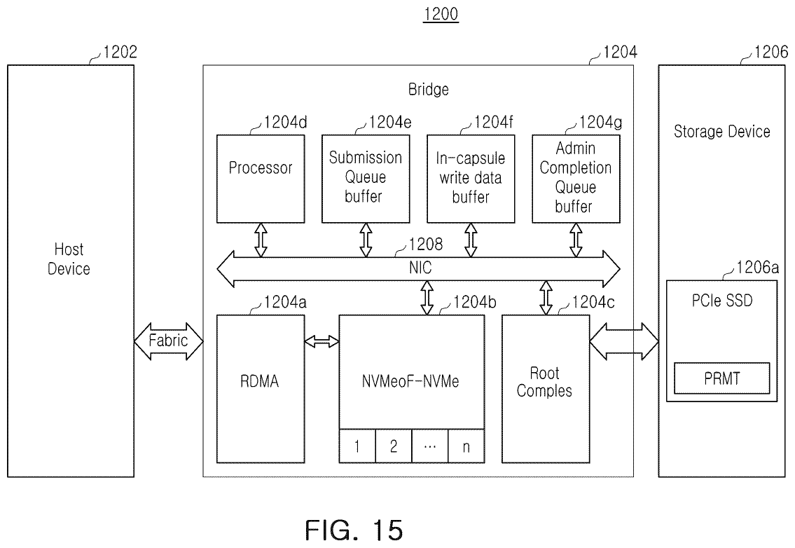

FIG. 15 is a diagram illustrating a host system according to at least one example embodiment. Referring to FIG. 15, the host system 1200 may include a host device 1202, a bridge device 1204, and a storage device 1206.

The host device 1202 may be at least one server, desktop computer, handheld device, multiprocessor system, microprocessor-based programmable consumer electronics device, laptop, network computer, minicomputer, or mainframe computer. Within the host system 1200, the host device 1202 may communicate with bridge device 1204 using a fabric interface protocol, such as an Ethernet Fabric. The fabric interface protocol may include at least one Fiber Channel.

The bridge device 1204 may be implemented to communicate with the storage device 1206 using an interface protocol such as PCIe. PCIe SSD 1206a may communicate with bridge device 1204 using the PCIe bus interface protocol. In this case, the interface protocol may also include at least one of Advanced Technology Attachment (ATA), Serial ATA (SATA), Serial Attached Small Computer System Interface (SAS), and/or the like. Additionally, the bridge device 1204 may include submodules such as remote direct memory access (RDMA) submodule (1204a), nonvolatile memory express (NVMe) over Fabrics-NVMe (NVMeoF-NVMe) submodule (1204b), RC submodule (1204c), processor (1204d), SQ buffer (1204e), in-capsule write data buffer (1204f), and Administrative (Admin) (ACQ) Completion Queue buffer (1204g). The NVMeoF-NVMe submodule 1204b may include at least one submodule such as a virtual data memory 1204ba and context memories 1204bb to 1204bn. The SQ buffer 1204e may include sets of commands, such as at least one Administrative (Admin) Submission Queue (ASQ) command and an Input/Output Submission Queue(s) (IOSQ) command of the controller of the bridge device 1204. The ACQ buffer 1204g may include a completion entry corresponding to an Admin queue (AQ) received from the storage device 1206. ASQ and subsequent ACQ may be used to submit administrative (Admin) commands and receive completion corresponding to the administrative command, respectively.

The storage device 1206 may be a nonvolatile memory device that stores data in a nonvolatile state. In addition, the host device 1202 may transmit the SQE to the bridge device 1204 through fabrics, and may be transmitted using the RDMA SEND operation through the RDMA submodule 1204a. When the storage device 1206 transmits a memory write TLP transaction or a memory read TLP transaction to the bridge device 1204 through the PCIe bus, access the virtual data memory (1204ba) of the read/write command. Accordingly, NVMeoF-NVMe submodule 1204b may decode the command token number from the virtual data memory address of virtual data memory 1204ba after accessing the data buffer.

The storage device 1206 may include a Peripheral Component Interconnect Express (PCIe) solid-state drive (SSD) 1206a that transmits and receives data according to the PCIe interface. In these cases, the PCIe SSD 1206a may store a parameter (PRMT) indicating the optimal clock value between performance/power, as described in FIGS. 1 to 14. In this case, the parameter (PRMT) is a value derived by machine learning, for example, Bayesian optimization, inside or outside the PCIe SSD (1206a).

The device described above may be implemented with processing circuitry such as hardware components, software components, and/or a combination of hardware components and software components. For example, the functional elements, such as those including “unit”, “ . . . er/or”, “module”, “logic”, etc., described in the specification represent elements that process at least one function or operation, and may be implemented as processing circuitry, and the devices and components described in the embodiment may be implemented using one or more general-purpose computers or special-purpose computers, along with a processor, a controller, an arithmetic logic unit (ALU), a digital signal processor, a microcomputer, a field programmable gate array (FPGA), a programmable logic unit (PLU), a microprocessor, application-specific integrated circuit (ASIC), and/or the like. The processing device may execute an operating system (OS) and one or more software applications running on the operating system. Additionally, a processing device may access, store, manipulate, process, and generate data in response to the execution of software. For ease of understanding, the processing device may be described as being used in some cases, but those skilled in the art will appreciate that a processing device may include a plurality of processing elements or multiple types of processing elements. For example, a processing device may include a plurality of processors or one processor and one controller. Additionally, other processing configurations, such as parallel processors, are also possible.

Software may include computer programs, code, instructions, or a combination of one or more thereof, and may configure processing devices to operate as required or command the processing devices independently or collectively. Software and/or data may be embodied in any type of machine, component, physical device, virtual equipment, computer storage medium, or device, to be interpreted by or to provide instructions or data to a processing device. Software may be distributed over networked computer systems and stored or executed in a distributed manner. Software and data may be stored on one or more computer-readable recording media.

The present invention determines the optimal clock value to minimize power consumption while meeting performance requirements by considering the trade-off using Bayesian Optimization. While there are embodiments that determine parameters within the SSD, parameters may also be determined externally and then embedded into the product. The optimization algorithm of the present invention is based on actual measured data and uses Bayesian Optimization (a machine learning algorithm) to decide parameter values through a Parameter Optimizer module. Considering the specifications, it defines the priority among objectives and may be equipped with an Objectives Aggregator, which aggregates multiple objectives to derive a single scalar value by minimizing trade-offs between these objectives.

According to an embodiment of the present invention, the storage device and the operating method thereof may optimize power efficiency using machine learning. According to another embodiment of the present invention, the storage device and the operating method may reduce development manpower wasted in the clock tuning process. While example embodiments have been illustrated and described above, it will be apparent to those skilled in the art that modifications and variations could be made without departing from the scope of the present inventive concepts as defined by the appended claims.

1. A storage device comprising:
at least one nonvolatile memory device including at least one internal component; and
a controller configured to control the at least one nonvolatile memory device,
wherein the controller includes a parameter storage configured to store a power parameter indicating a clock value of each of a plurality of internal configurations for each power state of each of the at least one internal component,
wherein the power parameter is derived by performing a machine learning operation using a machine learning model trained to output the power parameter based on performance, peak power, and average power of the storage device.

2. The storage device of claim 1, wherein the power state of each of the at least one internal component is one of an active state, a background operating state, an idle state, or a sleep state.

3. The storage device of claim 1, wherein the clock value is adjusted using at least one of a clock division value, a clock gating value, or a clock gearing value.

4. The storage device of claim 1, wherein the machine learning operation is performed in an external device of the storage device.

5. The storage device of claim 4, wherein the external device includes processing circuitry configured to
monitor the peak power and the average power according to a workload of the storage device;
derive a scalar value in which the performance, the peak power, and the average power are synthesized according to the workload of the storage device; and
derive the power parameter by performing the machine learning operation based on the scalar value.

6. The storage device of claim 5, wherein the processing circuitry is configured to determine the scalar value according to an equation.

7. The storage device of claim 1, wherein the machine learning operation is performed inside the storage device.

8. The storage device of claim 7, wherein the storage device includes processing circuitry configured to perform the machine learning operation in response to a request from a host device.

9. The storage device of claim 8, wherein the processing circuitry is configured to
monitor the peak power and the average power according to a workload of the storage device;
derive a scalar value in which the performance, the peak power, and the average power are synthesized according to the workload; and
derive the power parameter by performing the machine learning operation based on the scalar value.

10. The storage device of claim 1, wherein the
at least one internal component include a first core and a second core, and
when the first core is active and the second core is inactive a clock value of the first core is fixed and a clock value of the second core varies based on the power parameter.

11. A method of operating a storage device, the method comprising:
setting a power parameter using machine learning; and
adjusting a frequency of at least one active or inactive device based on the set power parameter,
wherein the adjusting of the frequency includes at least one of
dividing a clock corresponding to the frequency,
gating the clock, or
gearing the clock.

12. The method of claim 11, wherein setting the power parameter includes deriving, in an external device, the power parameter using the machine learning.

13. The method of claim 12, wherein the deriving of the power parameter includes
monitoring peak power and average power based on a workload of the storage device;
deriving a scalar value in which performance, the peak power, and the average power according to the workload are synthesized; and
determining the power parameter by performing a machine learning operation.

14. The method of claim 13, wherein the machine learning is configured to use a Bayesian optimization.

15. The method of claim 11, wherein setting the power parameter includes performing a machine learning operation in internal processing circuitry in response to a request from a host device.

16. A method of operating a storage device, the method comprising:
receiving a machine learning execution request from a host device;
performing a machine learning operation in response to the machine learning execution request; and
setting a parameter according to a result of execution of the machine learning operation,
wherein the parameter is a value derived considering performance, peak power, and average power.

17. The method of claim 16, wherein
the parameter indicates a clock value for each of a plurality of internal components of the storage device, and
wherein setting the parameter includes adjusting the clock value using at least one of a clock division value, a clock gating value, or a clock gearing value.

18. The method of claim 16, wherein
the parameter indicates quality parameters determining a service quality, and
the quality parameters include at least two of a program operation parameter, a buffer size, a core clock, firmware policy, or performance margin.

19. The method of claim 16, further comprising:
determining power states of a first core and a second core of the storage device; and
when the first core is active and the second core is inactive, fixing a clock value of the first core and varying a clock value of the second core based to the parameter.

20. The method of claim 16, further comprising:
receiving the performance and the power consumption of the storage device;
deriving a scalar value in which the performance and the power consumption for each workload are synthesized; and
performing the machine learning operation using the derived scalar value.

21.-25. (canceled)
